(19) United States
(12) Patent Application Publication
(10) Pub. No.: US 2018/0305525 A1
(43) Pub. Date: Oct. 25, 2018

(54) RUBBER COMPOSITION FOR VIBRATION-DAMPING RUBBER

(71) Applicant: TOYO TIRE & RUBBER CO., LTD., Itami-shi, Hyogo (JP)

(72) Inventor: Akira Oishi, Itami-shi (JP)

(73) Assignee: TOYO TIRE & RUBBER CO., LTD., Itami-shi, Hyogo (JP)

(21) Appl. No.: 15/771,804

(22) PCT Filed: Oct. 19, 2016
(86) PCT No.: PCT/JP2016/080954

§ 371 Date: Apr. 27, 2018

(30) Foreign Application Priority Data
Dec. 16, 2015 (JP) 2015-245114

(51) Int. Cl. C08L 7/00; C08L 9/00; C08K 3/08; C08K 5/3415; C08K 3/06; F16F 1/36

(52) U.S. Cl. CPC C08L 7/00; C08L 9/00; C08K 3/08; C08K 5/3415; F16F 2224/025; F16F 1/3605; C08L 2205/025; C08L 2205/03; C08K 2003/0893; C08K 3/06

(57) ABSTRACT

A rubber composition for vibration-damping rubber contains a rubber component comprising at least one or more diene-based rubbers, a complex zinc flower, and a bismaleimide compound. The rubber composition for vibration-damping rubber preferably contains 2 to 40 parts by weight of the complex zinc flower, and 0.5 to 5 parts by weight of the bismaleimide compound for 100 parts by weight of the rubber component.

### TECHNICAL FIELD

The present invention relates to a rubber composition for vibration-damping rubber, particularly, a rubber composition for vibration-damping rubber that is favorably usable for a vibration-damping member, such as an engine mount for an automobile; and a vibration-damping rubber, using this rubber composition.

### BACKGROUND ART

Hitherto, as vibration-damping rubbers, rubbers have been used in which carbon black as a reinforcing material is blended into natural rubber. In the market in recent years, vibration-damping rubbers, particularly, vibration-damping rubbers for automobiles are required to be decreased in dynamic magnification (“dynamic spring constant”/“static spring constant” ratio).

In order to decrease vibration-damping rubbers in dynamic magnification, it is important to heighten the dispersibility of carbon black in natural rubber. Hitherto, a method has been adopted in which as carbon black, a large particle diameter species thereof is used, thereby heightening the dispersibility of carbon black in natural rubber. However, this method tends to damage the endurance of vibration-damping rubbers.

Apart from the above, in a rubber composition, a vulcanization promoter is generally used together with a vulcanizer containing sulfur in order to shorten a period for the vulcanization thereof, lower the vulcanization temperature, and decrease the amount of the vulcanizer. One substance for activating this vulcanization promoter and making the promoting effect thereof higher is a metal oxide, a typical example of which is zinc oxide (zinc flower). Patent Document 1 listed below states that a vibration-damping rubber decreased in dynamic magnification can be yielded by blending a specified amount of zinc flower made into fine particles for 100 parts by weight of natural rubber, and further vulcanizing the resultant rubber composition. However, the present inventors have made eager investigations to find out that from the viewpoint of a decrease of vibration-damping rubbers in dynamic magnification, there remains a room for a further improvement of the technique described in this patent document.

Moreover, in some cases, vibration-damping rubbers used, particularly, in automobiles are intensely required to be improved in heat resistance together with the decrease in the dynamic magnification thereof. Patent Document 2 listed below discloses a technique for decreasing a vibration-damping rubber in dynamic magnification by blending 3 to 50 parts by weight of complex zinc flower into 100 parts by weight of a diene-based rubber component in a rubber composition. However, the present inventors have made eager investigations to find out that from the viewpoint of an improvement of vibration-damping rubbers in heat resistance, there remains a room for a further improvement.

### PRIOR ART DOCUMENTS

### Patent Documents

Patent Document 1: JP-A-2006-193621

Patent Document 2: JP-A-2014-77050

### SUMMARY OF INVENTION

### Problems to be SOLVED by the invention

In the light of the above-mentioned situation, the present invention has been made, and an object thereof is to provide a rubber composition for vibration-damping rubber which can be made compatible between a decrease in dynamic magnification and an improvement in heat resistance.

### Means for Solving the Problems

In order to solve the above-mentioned problems, the inventors have made eager investigations about combinations of a metal oxide with a bismaleimide compound. As a result, the inventors have found out that in the case of using, as a raw material, a rubber composition in which a combination of a complex zinc flower with a bismaleimide compound is blended into a diene-based rubber, a vibration-damping rubber can be obtained which is remarkably decreased in dynamic magnification and is excellent in heat resistance. The present invention has been made as a result of the investigations, and attains the object by the following:

The rubber composition for vibration-damping rubber according to the present invention comprises a rubber component comprising at least one or more diene-based rubbers, a complex zinc flower, and a bismaleimide compound. In the rubber composition for vibration-damping rubber according to the invention, a combination of a complex zinc flower with a bismaleimide compound is blended into a diene-based rubber. This blending decreases remarkably a vibration-damping rubber produced by use of this blend as a raw material in dynamic magnification, and improves this rubber particularly in heat resistance. In order that the produced vibration-damping rubber can attain the decrease in dynamic magnification and the improvement in heat resistance with a better balance, the rubber composition preferably comprises 2 to 40 parts by weight of the complex zinc flower, and 0.5 to 5 parts by weight of the bismaleimide compound for 100 parts by weight of the rubber component.

The rubber composition for vibration-damping rubber preferably further comprises sulfur, and more preferably comprises 0.05 to 1 part by weight of sulfur for 100 parts by weight of the rubber component. In the case of blending the combination of the complex zinc flower, the bismaleimide compound and sulfur into the diene-based rubber, and adjusting, particularly, the blend ratio between these three into the specified ratio, the produced vibration-damping rubber can attain the decrease in dynamic magnification and the improvement in heat resistance with an especially good balance.

### MODE FOR CARRYING OUT THE INVENTION

The rubber composition for vibration-damping rubber according to the present invention includes a rubber component comprising at least one or more diene-based rubbers, a complex zinc flower, and a bismaleimide compound.

The rubber composition for vibration-damping rubber according to the present invention includes, as a rubber component thereof, at least one diene-based rubber, preferably as a main ingredient. In the present invention, the wording “main ingredient” means that the rubber composition includes, as the rubber component, 50 parts or more by weight of the diene-based rubber. The composition includes, as the rubber component, preferably 80 parts or more, more preferably 95 parts by weight of the diene-based rubber. The diene-based rubber is, for example, natural rubber (NR); or a synthetic rubber. Examples of the latter include isoprene rubber (IR), butadiene rubber (BR), styrene butadiene rubber (SBR), butyl rubber (IIR), acrylonitrile butadiene rubber (NBR) and other diene-based rubbers; brominated butyl rubber (BR-IIR), and other halogenated butyl rubbers; and polyurethane rubber, acrylic rubber, fluorine-contained rubber, silicone rubber, chlorosulfonated polyethylene, and other synthetic rubbers.

The rubber composition for vibration-damping rubber according to the present invention includes a complex zinc flower. The composition includes this substance in an amount preferably from 2 to 40 parts by weight, more preferably from 3 to 30 parts by weight for 100 parts by weight of the rubber component. The complex zinc flower has a structure having, for example, CaCO₃, Ca(OH)₂, CaSO₄, ZnO, MgO, Mg(OH)₂ or MgCO₃ for a core as a carrier into the rubber, and a zinc flower with which the core is covered. This zinc flower is a zinc flower higher in activity than ordinary zinc flowers. The following ratio and other factors can be set at will: a ratio between the size of the core and the thickness of the cover layer of zinc flower. This complex zinc flower may be preferably a commercially available product, examples thereof include products of META-Z L series (META-Zs L40, L50 and L60).

The rubber composition for vibration-damping rubber according to the present invention includes a bismaleimide compound together with the complex zinc flower. The bismaleimide compound is in particular preferably a bismaleimide compound represented by the following general formula (1):

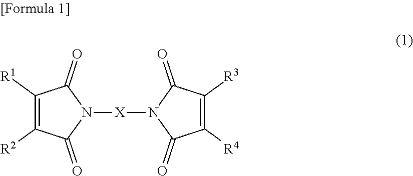

wherein R¹ to R⁴ each represent a hydrogen atom, or an alkyl, amino, nitro or nitroso group, and may be the same or different from each other; and X represents a bivalent organic group. Specific examples of the bismaleimide compound usable in the present invention include N,N′-M-phenylenebismaleimide, N,N′-(4,4′-diphenylmethane)bismaleimide, bis(3-ethyl-5-methyl-4-maleimidephenyl)methane, and 2,2′-bis(4-(4-maleimidephenoxy)phenyl)propane. In the rubber composition for vibration-damping rubber, the content of the bismaleimide compound blended together with the complex zinc flower is preferably from 0.5 to 5 parts by weight, more preferably from 0.6 to 4 parts by weight for 100 parts by weight of the rubber component.

The rubber composition for vibration-damping rubber according to the present invention preferably includes a sulfur-containing vulcanizer. The sulfur as this sulfur-containing vulcanizer is sufficient to be a sulfur for ordinary rubbers, and may be, for example, powdery sulfur, precipitated sulfur, insoluble sulfur, or highly dispersible sulfur. In the rubber composition for vibration-damping rubber according to the present invention, the sulfur content is preferably from 0.5 to 3 parts by weight for 100 parts by weight of the rubber component. Considering the heat resistance of a vibration-damping rubber to be produced, the sulfur content is in particular preferably from 0.05 to 1 part by weight.

As far as the advantageous effects of the present invention are not damaged, any blending agent used ordinarily in the rubbery industry may be appropriately used and blended, together with the above-mentioned rubber component, complex zinc flower, bismaleimide compound and sulfur-containing vulcanizer, into the rubber composition of the invention for vibration-damping rubber. Examples of the blending agent include a vulcanization promoter, carbon black, silica, a silane coupling agent, stearic acid, a vulcanization promotion aid, a vulcanization retardant, an antiaging agent, softening agents such as a wax and an oil, and a working aid.

The species of carbon black may be, for example, SAF, ISAF, HAF, FEF or GPF. Carbon black is usable as far as carbon black can adjust rubber properties of the vulcanized rubber, such as the hardness, reinforcing performance, and low exothermic property of the rubber. The blend amount of carbon black is preferably from 20 to 120 parts by weight, more preferably from 30 to 100 parts by weight, even more preferably from 30 to 60 parts by weight for 100 parts by weight of the rubber component. If this blend amount is less than 20 parts by weight, the rubber composition cannot sufficiently gain the reinforcing effect of carbon black. If the amount is more than 120 parts by weight, the rubber composition is deteriorated in exothermic property, miscibility into rubber, operability when worked, and others.

The vulcanization promoter may be a vulcanization promoter used usually for rubber vulcanization. Examples thereof include sulfenamide type, thiuram type, thiazole type, thiourea type, guanidine type, and dithiocarbamic acid salt type vulcanization promoters. Such promoters may be used singly or in an appropriate mixture form.

The antiaging agent may be an antiaging agent used usually for rubber. Examples thereof include aromatic amine type, amine-ketone type, monophenolic type, bisphenolic type, polyphenolic type, dithiocarbamic acid salt type, and thiourea type antiaging agents. Such agents may be used singly or in an appropriate mixture form.

The rubber composition of the present invention for vibration-damping rubber can be obtained by kneading the above-mentioned rubber component, complex zinc flower, bismaleimide compound and sulfur-containing vulcanizer, and optional components, which are, for example, carbon black, stearic acid, silica, a vulcanization promoter, an antiaging agent, and wax, using a kneading machine used in an ordinary rubber industry, such as a Banbury mixer, a kneader, or a roller.

The method for blending the individual components with each other is not particularly limited, and may be, for example, any one of the following: a method of kneading, in advance, kneading components other than the sulfur-containing vulcanizer, the vulcanization promoter and other vulcanization-related components to prepare a masterbatch, adding the remaining components thereto, and further kneading the resultant; a method of adding the individual components in any order to a machine as described above, and then kneading the resultant; and a method of adding all the components simultaneously to the same machine, and kneading the resultant.

After the individual components are kneaded and then the resultant is worked and shaped, the shaped body is vulcanized. In this way, a vibration-damping rubber low in dynamic magnification can be produced. This vibration-damping rubber is usable suitably for vibration-damping rubbers for automobiles, for example, for their engine mounts, torsional dampers, body mounts, member mounts, strut mounts and muffler mounts, and suitably for vibration-damping rubbers for railway vehicles, and vibration-damping rubbers for industrial machines. The vibration-damping rubber is particularly useful for engine mounts and other constituent members of vibration-damping rubbers for automobiles, for which a low dynamic magnification and heat resistance are required.

### EXAMPLES

Hereinafter, this invention will be more specifically described by demonstrating working examples thereof.

### (Preparation of Each Rubber Composition)

In accordance with a blending formulation in Table 1, a rubber composition in each of Examples 1 to 13, and Comparative Examples 1 and 2 was blended into 100 parts by weight of one or more rubber components. An ordinary Banbury mixer was used to knead the blend to prepare a rubber composition. Individual blending agents described in Table 1 are as follows:

a) Rubber components

Natural rubber (NR): “RSS#3”

Isoprene rubber (IR) : “IR2200” (manufactured by JSR Corp.)

Butadiene rubber (BR): “BR01” (manufactured by JSR Corp.)

Styrene-butadiene rubber (SBR): “Nipol NS116R” (manufactured by Zeon Corp.)

b) Complex zinc flower: “META-Z L60” (manufactured by Inoue Calcium Corp.)

Zinc oxide: “No. 3 ZnO” (manufactured by Mitsui Mining & Smelting Co., Ltd.)

c) Stearic acid (manufactured by NOF Corp.)
d) Carbon black: “SEAST SO” (manufactured by Tokai Carbon Co., Ltd.)
e) Antiaging agent: “NOCRAC 6C” (manufactured by Ouchi Shinko Chemical Industrial Co., Ltd.)
f) Aroma oil: “PROCESS X-140” (manufactured by Japan Energy Corp.)
g) Sulfur: 5%-Sulfur-treated sulfur
h) Vulcanization promoters

(A) Sulfenamide type vulcanization promoter: N-cyclohexyl-2-benzothiazolesulfenamide: “NOCCELER CZ”, manufactured by Ouchi Shinko Chemical Industrial Co., Ltd.

(B) Thiuram compound: Tetramethylthiuram monosulfide: “NOCCELER TT”, manufactured by Ouchi Shinko Chemical Industrial Co., Ltd.

i) Bismaleimide compounds

(A) 4,4′-Diphenylmethanebismaleimide: “BMI-HS” (manufactured by K.I Chemical Industry Co., Ltd.)

(B) N,N′-phenylenebismaleimide: “VULNOC PM-P” (manufactured by Ouchi Shinko Chemical Industrial Co., Ltd.)

### (Evaluations)

A predetermined mold was used to heat and vulcanize each of the rubber compositions at 170° C. for 20 minutes. The resultant rubber was evaluated.

### <Dynamic Magnification>

### (Static Spring Constant (Ks))

While each of the rubber compositions was vulcanized and press-formed, a vulcanized rubber sample was produced which had a columnar shape (diameter: 50 mm, and height: 25 mm), and then an adhesive was used to bond a pair of columnar metallic tools (diameter: 60 mm, and thickness: 6 mm), respectively, onto the upper and lower surfaces of the vulcanized rubber sample. In this way, a test piece was produced. The produced test piece was compressed by 7 mm two times into the columnar axis direction. Thereafter, when a strain thereof was being restored, the deflection load of the test piece at 1.5 mm and that at 3.5 mm were measured from the resultant load-deflection curve thereof. From these values, the static spring constant (Ks) (N/mm) was calculated out.

### (Dynamic Spring Constant (Kd))

The test piece used when the static spring constant (Ks) was measured was compressed by 2.5 mm into the columnar axis direction. From below the piece, a constant-displacement compressive harmonic vibration having an amplitude of 0.05 mm was applied at a frequency of 100 Hz to the piece around the position of the piece where the piece had been compressed by 2.5 mm, which was the center of the vibration. Using the upper load cell, the dynamic load was detected, and then in accordance with JIS-K 6394, the dynamic spring constant (Kd) (N/mm) of the piece was calculated out.

### (Dynamic Magnification: Kd/Ks)

The dynamic magnification of the test piece was calculated out in accordance with the following expression:

“Dynamic magnification”=“dynamic spring constant (Kd)”/“Static spring constant (Ks)”

On the basis of the calculated dynamic spring constant and static spring constant, the dynamic magnification was calculated. The target value of the dynamic magnification was set to 2.0 or less. When the test piece attained this target value, the piece was estimated to be good (circular mark); or when the test piece did not attain this target value, the piece was estimated to be bad (cross mark). The estimation results are shown in Table 1.

### <Heat Resistance>

A sample of each of the examples that was produced by using a JIS No. 3 dumbbell was allowed to stand still in an oven of 100° C. temperature for 72 hours to be aged. The sample was taken out, and then cooled to room temperature. On the basis of JIS K 6251, the elongation at break (EB (%)) of the sample was measured. The retention proportion (%) of the elongation at break to the breaking elongation before the thermal aging was calculated out. As a sample is larger in retention proportion, the sample is better in heat resistance. The target value of the retention proportion was set to 70(%) or more. When the sample attained this target value, the sample was estimated to be good (circular mark); or when the sample did not attain this target value, the sample was estimated to be bad (cross mark). The estimation results are shown in Table 1.

TABLE 1

| | | Compar- | Compar- | | | | | | | |
|---|---|---|---|---|---|---|---|---|---|---|
| | | ative | ative | Ex- | Ex- | Ex- | Ex- | Ex- | Ex- | Ex- |
| | | Example | Example | ample | ample | ample | ample | ample | ample | ample |
| | | 1 | 2 | 1 | 2 | 3 | 4 | 5 | 6 | 7 |
| Blend | Carbon black | 50 | 50 | 50 | 50 | 50 | 50 | 50 | 50 | 50 |
| | Aroma oil | 10 | 10 | 10 | 10 | 10 | 10 | 10 | 10 | 10 |
| | Stearic acid | 1 | 1 | 1 | 1 | 1 | 1 | 1 | 1 | 1 |
| | Antiaging | 1 | 1 | 1 | 1 | 1 | 1 | 1 | 1 | 1 |
| | agent | | | | | | | | | |
| | Vulcanization | 3 | 3 | 3 | 3 | 3 | 3 | 3 | 3 | 3 |
| | promoter A | | | | | | | | | |
| | Vulcanization | 0.5 | 0.5 | 0.5 | 0.5 | 0.5 | 0.5 | 0.5 | 0.5 | 0.5 |
| | promoter B | | | | | | | | | |
| | NR | 80 | 80 | 80 | 80 | 80 | 80 | 80 | 80 | 100 |
| | IR | | | | | | | | | |
| | BR | 20 | 20 | 20 | 20 | 20 | 20 | 20 | 20 | |
| | SBR | | | | | | | | | |
| | Zinc oxide | 10 | 10 | | | | | | | |
| | Complex Zinc | | | 10 | 10 | 10 | 3 | 30 | 10 | 10 |
| | flower | | | | | | | | | |
| | Bismaleimide | | 1 | 1 | 1 | 1 | 1 | 1 | | 1 |
| | compound A | | | | | | | | | |
| | Bismaleimide | | | | | | | | 1 | |
| | compound B | | | | | | | | | |
| | Sulfur | 1.5 | 1.5 | 1.5 | 0.1 | 3 | 1.5 | 1.5 | 1.5 | 1.5 |
| Eval- | Kd/Ks ratio | 1.87 | 1.90 | 1.73 | 1.98 | 1.55 | 1.85 | 1.68 | 1.74 | 1.81 |
| uations | target value | ∘ | ∘ | ∘ | ∘ | ∘ | ∘ | ∘ | ∘ | ∘ |
| | <2.0 | | | | | | | | | |
| | Heat | 63 | 68 | 78 | 92 | 71 | 74 | 80 | 75 | 79 |
| | resistance (%) | x | x | ∘ | ∘ | ∘ | ∘ | ∘ | ∘ | ∘ |
| | Target value | | | | | | | | | |
| | >70 | | | | | | | | | |

| | | Ex- | Ex- | Ex- | Ex- | Ex- | Ex- |
|---|---|---|---|---|---|---|---|
| | | ample | ample | ample | ample | ample | ample |
| | | 8 | 9 | 10 | 11 | 12 | 13 |
| Blend | Carbon black | 50 | 50 | 50 | 50 | 50 | 50 |
| | Aroma oil | 10 | 10 | 10 | 10 | 10 | 10 |
| | Stearic acid | 1 | 1 | 1 | 1 | 1 | 1 |
| | Antiaging | 1 | 1 | 1 | 1 | 1 | 1 |
| | agent | | | | | | |
| | Vulcanization | 3 | 3 | 3 | 3 | 3 | 3 |
| | promoter A | | | | | | |
| | Vulcanization | 0.5 | 0.5 | 0.5 | 0.5 | 0.5 | 0.5 |
| | promoter B | | | | | | |
| | NR | 80 | 80 | | | 80 | 80 |
| | IR | | | 100 | 80 | | |
| | BR | | 10 | | 20 | 20 | 20 |
| | SBR | 20 | 10 | | | | |
| | Zinc oxide | | | | | | |
| | Complex Zinc | 10 | 10 | 10 | 10 | 10 | 10 |
| | flower | | | | | | |
| | Bismaleimide | 1 | 1 | 1 | 1 | 1 | 1 |
| | compound A | | | | | | |
| | Bismaleimide | | | | | | |
| | compound B | | | | | | |
| | Sulfur | 1.5 | 1.5 | 1.5 | 1.5 | 1 | 0.5 |
| Eval- | Kd/Ks ratio | 1.88 | 1.86 | 1.80 | 1.89 | 1.83 | 1.91 |
| uations | target value | ∘ | ∘ | ∘ | ∘ | ∘ | ∘ |
| | <2.0 | | | | | | |
| | Heat | 76 | 77 | 78 | 77 | 84 | 88 |
| | resistance (%) | ∘ | ∘ | ∘ | ∘ | ∘ | ∘ |
| | Target value | | | | | | |
| | >70 | | | | | | |

1. A rubber composition for vibration-damping rubber, comprising a rubber component comprising at least one or more diene-based rubbers, a complex zinc flower, and a bismaleimide compound.

2. The rubber composition for vibration-damping rubber according to claim 1, comprising 2 to 40 parts by weight of the complex zinc flower, and 0.5 to 5 parts by weight of the bismaleimide compound for 100 parts by weight of the rubber component.

3. The rubber composition for vibration-damping rubbers according to claim 1, further comprising sulfur.

4. The rubber composition for vibration-damping rubber according to claim 1, comprising 0.05 to 1 part by weight of sulfur for 100 parts by weight of the rubber component.
